(19) United States
(12) Patent Application Publication
(10) Pub. No.: US 2016/0379258 A1
(43) Pub. Date: Dec. 29, 2016

(54) Bid Based Search System

(71) Applicant: Quixey, Inc., Mountain View, CA (US)

(72) Inventor: Michael Harris, Mountain View, CA (US)

(73) Assignee: Quixey, Inc., Mountain View, CA (US)

(21) Appl. No.: 14/747,509

(22) Filed: Jun. 23, 2015

(51) Int. Cl. G06Q 30/02; G06F 17/30

(52) U.S. Cl. CPC G06Q 30/0256; G06Q 30/0275; G06F 17/30864

(57) ABSTRACT

A method includes receiving a search query from a general purpose search system or a user device and assessing a search query value for the search query. Sending a request for search results to search engines and receiving candidate search results from at least some of the search engines. The request includes the search query and the search query value. Each candidate search result includes a user selectable link and a result bid, the user selectable link indicates an operation to access information. Selecting search results from the candidate search results based on the corresponding result bids and sending the search results to the general purpose search system or the user device. Receiving an indication of a selection of a user selectable link of one of the search results and modifying an account associated with the search engine corresponding to the selected search result.

### TECHNICAL FIELD

This disclosure relates to bid based search systems.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications, games, educational applications, news applications, shopping applications, messaging applications, media streaming applications, social networking applications, and so much more. Furthermore, application developers develop vast amounts of applications within each genre and each application may have numerous editions.

### SUMMARY

One aspect of the disclosure provides a method for performing search. The method includes receiving, at data processing hardware, a search query from a general purpose search system or a user device in communication with the data processing hardware and assessing, by the data processing hardware, a search query value for the search query. The method also includes sending a request for search results from the data processing hardware to search engines and receiving, at the data processing hardware, candidate search results from at least some of the search engines. The request includes the search query and the search query value. Each candidate search result includes a user selectable link and a result bid, the user selectable link indicates an operation to access information. The method also includes selecting, by the data processing hardware, actual search results from the candidate search results based on the corresponding result bids and sending the actual search results from the data processing hardware to the general purpose search system or the user device. The method further includes receiving, at the data processing hardware, an indication of a selection of a user selectable link of one of the actual search results and modifying an account associated with the search engine corresponding to the selected actual search result.

Implementations of the disclosure may include one or more of the following optional features. In some implementations, the method includes sending at least one advertisement with the actual search results from the data processing hardware to the general purpose search system or the user device. The method may also include selecting the at least one advertisement from a collection of advertisements based on the search query. The method may include selecting the at least one advertisement from the collection of advertisements based on a price-per-action value and a probability of action of each advertisement. The action may include a user selection of the advertisement.

In some examples, the search query value is based on a probability of a user selection of the at least one advertisement for the search query. At least one advertisement may include advertisement data and an advertisement access mechanism having a reference to a corresponding application installed on the user device. The advertisement access mechanism may indicate a performable operation for the corresponding application relating to the advertisement. The user selectable link may include an application access mechanism associated with an application executable on the user device. The access mechanism may indicate a performable operation for the corresponding application. Each candidate search result may include at least one of an image or text. At least one candidate search result may include an advertisement.

In some implementations, the method includes receiving, at the data processing hardware, the candidate search results for a threshold period of time. After the threshold period of time, the method may include ceasing receipt of the candidate search results and selecting, by the data processing hardware, actual search results from the candidate search results received during the threshold period of time. The method may also include ordering, by the data processing hardware, the actual search results based on the corresponding result bids. Modifying the account associated with the search engine corresponding to the selected actual search result may include crediting the account with a payout value based on the result bid corresponding to selected actual search results. Modifying the account associated with the search engine corresponding to the selected actual search result may further include crediting the account with a payout value based on the search query value corresponding to selected actual search results. The result bid may be limited to less than the search query value.

Another aspect of the disclosure provides a system for performing search. The system includes data processing hardware and memory hardware in communication with the data processing hardware. The memory hardware stores instructions that when executed on the data processing hardware cause the data processing hardware to perform operations. The operations include receiving a search query from a general purpose search system or a user device in communication with the data processing hardware, assessing a search query value for the search query, and sending a request for search results to search engines. The request includes the search query and the search query value. The operations further include receiving candidate search results from at least some of the search engines, selecting actual search results from the candidate search results based on the corresponding result bids and send the actual search results to the general purpose search system or the user device. Each candidate search result includes a user selectable link and a result bid. The user selectable link indicates an operation to access information. The operations further include receiving an indication of a selection of a user selectable link of one of the actual search results and modifying an account associated with the search engine corresponding to the selected actual search result.

This aspect may include one or more of the following optional features. The operations may further include sending at least one advertisement with the actual search results from the data processing hardware to the general purpose search system or the user device. The operations may also include selecting the at least one advertisement from a collection of advertisements based on the search query. The operations may include selecting the at least one advertisement from the collection of advertisements based on a price-per-action value and a probability of action of each advertisement. The action may include a user selection of the advertisement.

The search query value may be based on a probability of a user selection of the at least one advertisement for the search query. At least one advertisement may include advertisement data and an advertisement access mechanism having a reference to a corresponding application installed on the user device. The advertisement access mechanism may indicate a performable operation for the corresponding application relating to the advertisement.

In some implementations, the user selectable link may include an application access mechanism associated with an application executable on the user device. The access mechanism may indicate a performable operation for the corresponding application. Each candidate search result may include at least one of an image or text. At least one candidate search result may further include an advertisement.

In some examples, the operations further include receiving the candidate search results for a threshold period of time. After the threshold period of time, the operations include ceasing receipt of the candidate search results and selecting actual search results from the candidate search results received during the threshold period of time. The operations may further include ordering the actual search results based on the corresponding result bids.

In some implementations, the operations include ordering the actual search results based on the corresponding result bids. Modifying the account associated with the search engine corresponding to the selected actual search result may include crediting the account with a payout value based on the result bid corresponding to selected actual search results. Modifying the account associated with the search engine corresponding to the selected actual search result may further include crediting the account with a payout value based on the search query value corresponding to selected actual search results.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example environment including a user device in communication with a search system.

FIG. 1B is a functional block diagram of a search system interacting with a search engine, advertisement system, and user devices.

FIG. 2A is a schematic view of an example user device in communication with a search system.

FIG. 2B is a functional block diagram of a search system interacting with a search engine and an account.

FIG. 3A is a functional block diagram of a search system interacting with a user device, a search engine, and an account.

FIG. 3B is a functional block diagram of a search system interacting with a user device, a search engine, an advertisement module, and an account.

FIG. 4 is a method of operating the search system.

FIG. 5 is a schematic view of an example computing device executing any systems or methods described herein.

Like reference symbols in the various drawings indicate like elements.

### DETAILED DESCRIPTION

A search system of the present disclosure implements a search based on a query received from a user device. The search system assesses a value for the query based on one or more factors and requests or queries search engines for candidate results and/or bids for the candidate results based the search query. The request to the search engines may be in the form of a search offer, which may include the assessed value of the query, the search query or some derivation thereof, and/or context parameters. The search engines may use the search offer to determine candidate results and corresponding bids for each result. The bid may correspond to an amount that the search engine is willing to pay to have the results shown in a search engine results page (SERP) or other results listing. The search system may receive candidate results and corresponding result bids from one or more search engines. Some search engines may elect to not return any candidate results or results bids based on the search offer, while other search engines may return many candidate results and results bids. In some examples, each candidate result has a corresponding result bid in a one-to-one relationship, while in other examples, the candidate results the result bids may have a one-to-many or many-to-many relationship.

The search system may select actual results from the candidate results based on the corresponding result bids, and transmits the actual results to a remote system or the user device. The results may include various mechanisms for accessing information or applications (e.g., allowing the user to find a restaurant) relevant to the query of the user. For example, in response to selection of an application access mechanism, the user device may launch an application referenced in the application access mechanism and perform one or more operations indicated in the application access mechanism. When a user interacts with an actual result, the search system may modify an account (e.g., apply a credit) associated with search engine. Referring back to the previous example, upon launch or user operation of the application, the search system may deposit a credit into an account of the search engine the provided the corresponding candidate result.

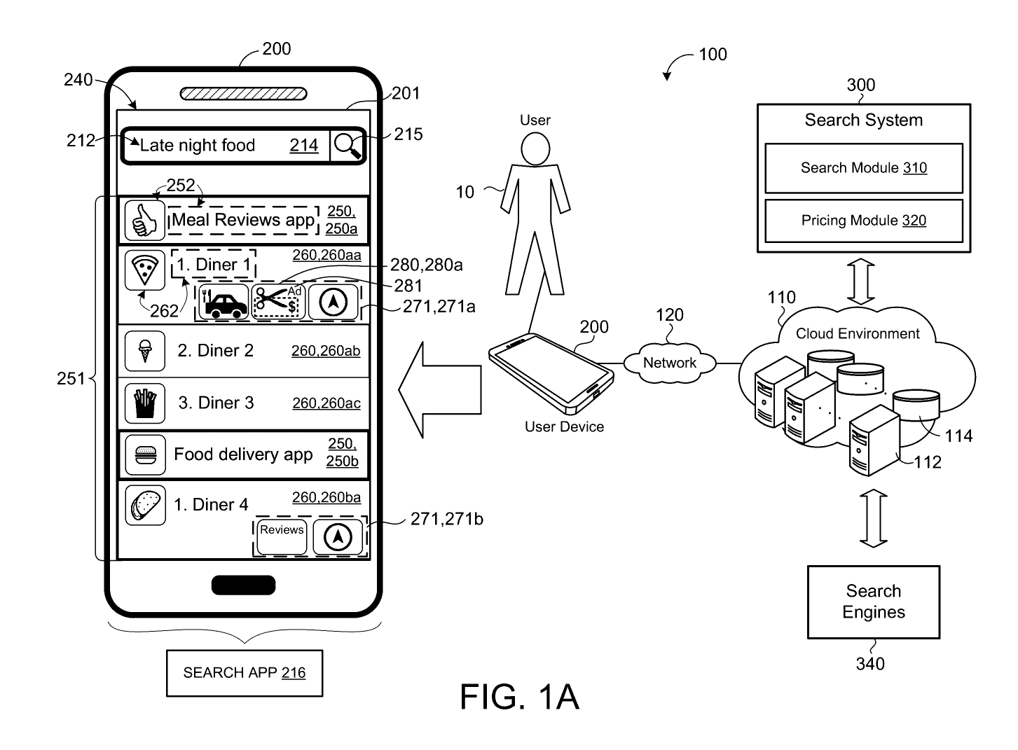

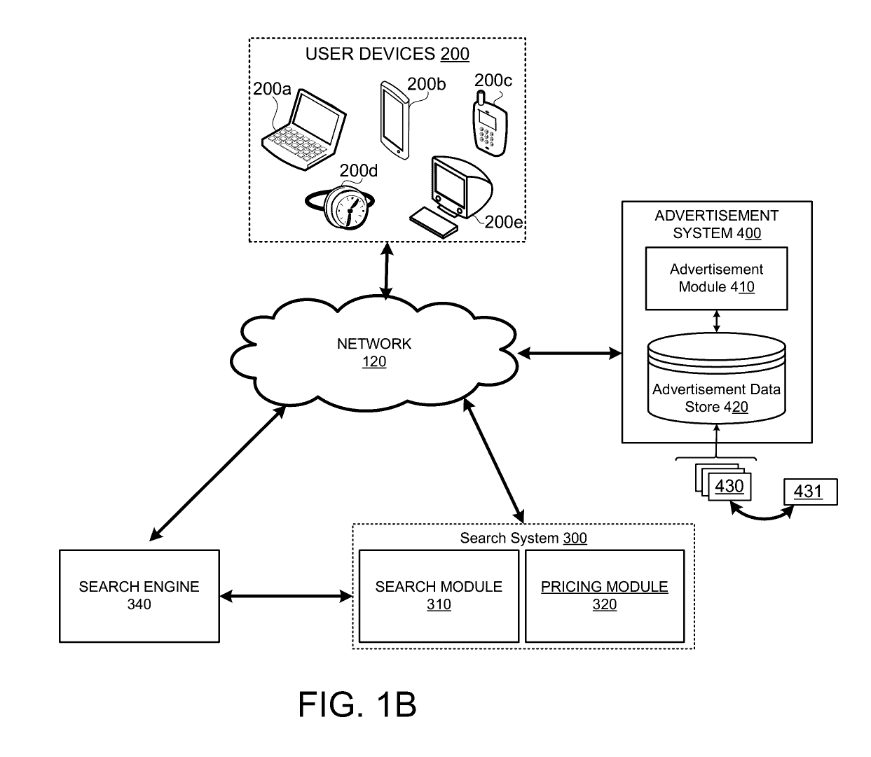

FIG. 1A illustrates an example system 100 that includes a user device 200 associated with a user 10 in communication with a remote system 110 via a network 120. FIG. 1B provides a functional block diagram of the system 100. The remote system 110 may be a distributed system (e.g., cloud environment) having scalable/elastic computing resources 112 and/or storage resources 114. The user device 200 and/or the remote system 110 may execute a search system 300. In some implementations, the search system 300 communicates with search engines 340 via the network 120. The network 120 may include various types of networks, such as a local area network (LAN), wide area network (WAN), and/or the Internet. In some implementations, the search system 300 includes a search module 310 and a pricing module 320.

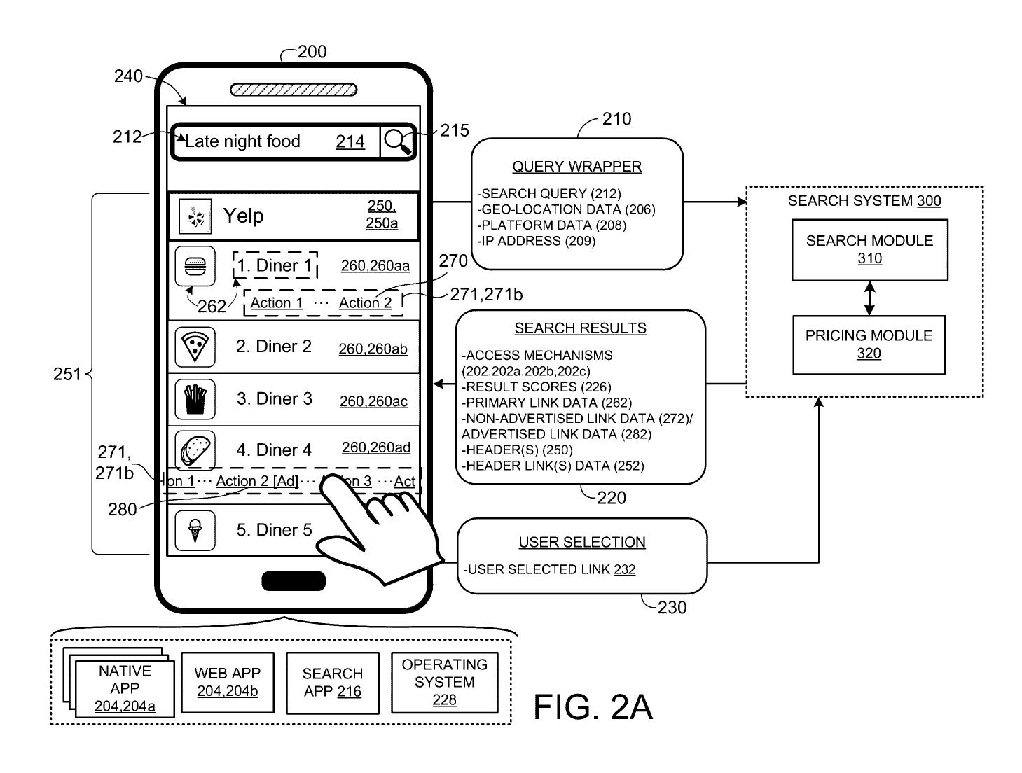

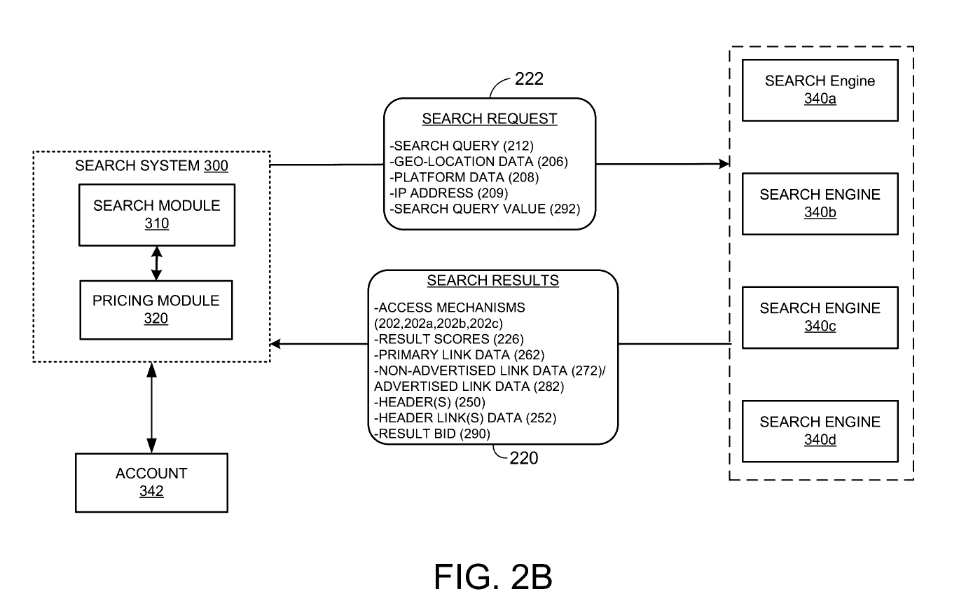

Referring to FIGS. 2A and 2B, the search system 300 receives a query wrapper 210 and requests search results 220. The search results 220 include one or more access mechanisms 202 that the user device 200 can use to access different functions for a variety of different applications 204, such as native applications 204a installed on the user device 200. The search system 300 transmits search results 220 including a list of access mechanisms 202 to the user device 200 that generated the query wrapper 210.

Referring to FIGS. 1A-2B, the modules 310, 320 of the search system 300 are in communication with one another. The search system 300 is configured to receive a query wrapper 210 (including a search query 212) from a user device 200. A user 10 may enter the search query 212 in a search field 214 of a graphical user interface (GUI) 240 of a search application 216 executing on the user device 200. The search system 300 is configured to output search results 220 based on the received query wrapper 210. The GUI 240 of the user device 200 displays the search results 220 including primary link(s) 260 and any, if available, one or more secondary links 271 optionally including advertisement links 280, where the secondary links 271 are associated with a primary link 260. The search module 310 and pricing module 320 receives a query wrapper 210 and generates a search request 222 based on the query wrapper 210. The search module 310 and pricing module 320 communicate the search request 222 to the search engines 340a . . . 340d. The search engines 340a . . . 340d then return the search results 220 with corresponding result bids 290. The pricing module 320 orders the search results 220 based upon the result bids 290 and outputs the ordered search results 220. Therefore, referring back to FIG. 1A, the search system 300 allows the GUI 240 of the user device 200 to display one or more primary user selectable links 260 grouped under a header 250 that includes a name of an application 204a, where each one of the primary links 260 is associated with the application 204a displayed in the header 250, and each one or more secondary user selectable links 270, 280 is associated with the primary user-selectable link 260 based on the search results, as will be discussed in more detail below.

FIGS. 1A-2A show an example user device 200 in communication with the search system 300. User devices 200 can be any computing devices that are capable of providing queries to the search system 300. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances).

The user devices 200 may use a variety of different operating systems 228. In examples where a user device 200 is a mobile device, the user device 200 may run an operating system 228 including, but not limited to, ANDROID® developed by Google Inc., IOS® developed by Apple Inc., or WINDOWS PHONE® developed by Microsoft Corporation. Accordingly, the operating system 228 running on the user device 200 may include, but is not limited to, one of ANDROID®, IOS®, or WINDOWS PHONE®. In an example where a user device 200 is a laptop or desktop computing device, the user device 200 may run an operating system 228 including, but not limited to, MICROSOFT WINDOWS® by Microsoft Corporation. MAC OS® by Apple, Inc., or Linux. User devices 200 may also access the search system 300 while running operating systems 228 other than those operating systems 228 described above, whether presently available or developed in the future.

A software application 204 (i.e., a software resource) may refer to computer software that causes a computing device to perform a task. In some examples, a software application 204 is referred to as an “application,” an “app,” or a “program.” Example applications 204 include, but are not limited to, system diagnostic applications, system management applications, system maintenance applications, word processing applications, spreadsheet applications, messaging applications, media streaming applications, social networking applications, and gaming applications.

Applications 204 can be executed on a variety of different user devices 200. In some examples, a native application 204a is installed on a user device 200 prior to a user 10 purchasing the user device 200. In other examples, the user 10 may download and install native applications 204a on the user device 200. Native applications 204a can perform a variety of different functions for a user 10. For example, a restaurant reservation application can make reservations for restaurants. As another example, an internet media player application can stream media (e.g., a song or movie) from the Internet. In some examples, a single native application 204a can perform more than one function. For example, a restaurant reservation application may also allow a user 10 to retrieve information about a restaurant and read user reviews for the restaurant in addition to making reservations. As another example, an internet media player application may also allow a user 10 to perform searches for digital media, purchase digital media, and generate media playlists.

The user 10 may access the functionality of an application 204 on the user device 200 on which the application 204 is installed. Additionally or alternatively, the user 10 may access the functionality of an application 204 via a remote computing device. In some examples, all of an application's functionality is included on the user device 200 on which the application 204 is installed. These applications 204 may function without communication with other computing devices (e.g., via the Internet). In additional examples, an application 204 installed on a user device 200 may access information from other remote computing devices during operation. For example, a weather application installed on a user device 200 may access the latest weather information via the Internet and display the accessed weather information to the user 10 through the installed weather application. In further examples, an application 204 (e.g., a web-browser application 204b) may be partially executed by the user device 200 and partially executed by a remote computing device 500. For example, a web-browser application 204b may be an application 204 that is executed, at least in part, by a web server and accessed by a web browser of the user device 200. Example web applications 204b may include, but are not limited to, web-based email, online auctions, and online retail sites.

In general, the user device 200 may communicate with the search system 300 using any software application 204 that can transmit search queries 212 to the search system 300. In some examples, the user device 200 runs a native application 204a that is dedicated to interfacing with the search system 300, such as a native application 204a dedicated to searches (e.g., a search application 216). In some examples, the user device 200 communicates with the search system 300 using a more general application 204, such as a web-browser application 204b accessed using a web browser native application 204a. Although the user device 200 may communicate with the search system 300 using the native search application 216 and/or a web-browser application 204b, the user device 200 may be described hereinafter as using the native search application 216 to communicate with the search system 300. In some implementations, the functionality attributed to the search application 216 may be included as a searching component of a larger application 204 that has additional functionality. For example, the functionality attributed to the search application 216 may be included as part of a native application 204a or a web application 204b as a feature that provides search capabilities.

The user device 200 generates user selectable links 250, 260, 270, 280 based on the received search results 220. Each user selectable link 250, 260, 270, 280 displayed to the user 10 may include an access mechanism 202. The user 10 may select a user selectable link 250, 260, 270, 280 on the user device 200 by interacting with the link 250, 260, 270, 280 (e.g., touching or clicking the link). In response to selection of a link 250, 260, 270, 280, the user device 200 may launch a corresponding software application 204 (e.g., a native application 204a or a web-browser application 204b) referenced by the access mechanism 202 and perform one or more operations indicated in the access mechanism 202.

Referring to FIGS. 1A-2B, in some implementations, the search system 300 includes a search module 310 and a pricing module 320. The search module 310 receives a query wrapper 210 and the pricing module 320 uses the information contained in the query wrapper 210 to determine a search query value 292. The search query value 292 can be based on a multitude of factors including the number of times a similar search is placed, the value estimate to the user 10, and the value estimate of the search to the search engine 340. After the pricing module 320 has generated a search query value 292, the search module 310 bundles the query wrapper 210 and search query value 292 into a search request 222 and sends the search request 222 to search engines 340a . . . d. Depending on the search query value 292, various search engines 340a . . . d can choose to return a search result 220 including a result bid 290. The result bid 290 indicates the amount of money the search engine is willing to pay to be included in the search results 220 to the user devices 200 and displayed in the list 251. Upon receipt of the search results 220 from the search engines 340a . . . d, the pricing module 320 charges an account 342 associated with the search engine 340 that provided the search results 220. The search system 300 may order the search results 220 in the list 251 based on various factors. In some examples, the search results 220 are ordered in the list 251 based on the corresponding result bids 290 (e.g., highest price to lowest price). The search system 300 may send the ordered search results 220 to the user device 200 in the list 251 or to an intermediary system in communication with the user device 200. Upon selection of one of the search results 220 by the user 10, the user device 200 returns a user selection 230 including the user selected link 232 (or identifier thereof) to the search system 300. The pricing module 320 uses the user selection 230 to credit the account 342 of the search engine 340 that provided the selected search result 220 in the amount of the search query value 292 or some value based on the search query value 292. Other payment schemes are possible as well.

The search module 310 is configured to receive a query wrapper 210 from the user device 200 via the network 120. A query wrapper 210 may include a search query 212, which may include text, numbers, and/or symbols (e.g., punctuation) entered into the user device 200 by the user 10. For example, the user 10 may enter the search query 212 into a search field 214 (e.g., a search box) of a graphical user interface (GUI) 240 of a search application 216 running on the user device 200. A user 10 may enter a search query 212 using a touchscreen keypad, a mechanical keypad, a speech-to-text program, or other form of user input. In general, a search query 212 may be a request for information retrieval (e.g., search results 220) from the search system 300. In some examples, the user 10 enters a search query 212 into a search field 214 of the GUI 240 and the GUI 240 displays search results 220 (via the search application 216) as the user 10 is inputting the text. In other examples, the user 10 selects a search button 215 before the system 100 executes the search system 300 and the search engines 340. For example, a search query 212 may be directed to retrieving a list 251 of links 260, 271 to application functionality or application states in examples where the search system 300 is configured to generate a list 251 of access mechanisms 202 as search results 220. A search query 212 directed to retrieving a list 251 of links 260, 271 to application functionality may indicate a user's desire to access functionality of one or more applications 204 described by the search query 212 and displayed in the header 250.

The query wrapper 210 may include additional data along with the search query 212. For example, the query wrapper 210 may include geo-location data 206 that indicates the location of the user device 200, such as latitude and longitude coordinates. The user device 200 may include a global positioning system (GPS) receiver that generates the geo-location data 206 transmitted in the query wrapper 210. The query wrapper 210 may also include an IP address 209, which the search module 310 may use to determine the location of the user device 200. In some examples, the query wrapper 210 also includes additional data, including, but not limited to, platform data 208 (e.g., version of the operating system 228, device type, and web-browser version), an identity of a user 10 of the user device 200 (e.g., a username), partner specific data, and other data.

The search system 300 can use the search query 212 and the additional data included in the query wrapper 210 to generate the search request 222 and search query value 292. For example, the search system 300 can determine a geo-location of the user device 200, which the search module 310 can use along with the search query 212 to select search engines 340a . . . d or to determine the search query value 292. The search system 300 can determine the geo-location of the user device 200 based on the geo-location data 206 or other data (e.g., IP address 209) included in the query wrapper 210. In some implementations, the search module 310 detects a location (e.g., a postal address, street name, city name, etc.) specified in the search query 212 (i.e., a query-specified location). In these implementations, the search module 310 can use the query-specified location along with the search query 212 to select search engines 340a . . . d or to determine a search query value 292.

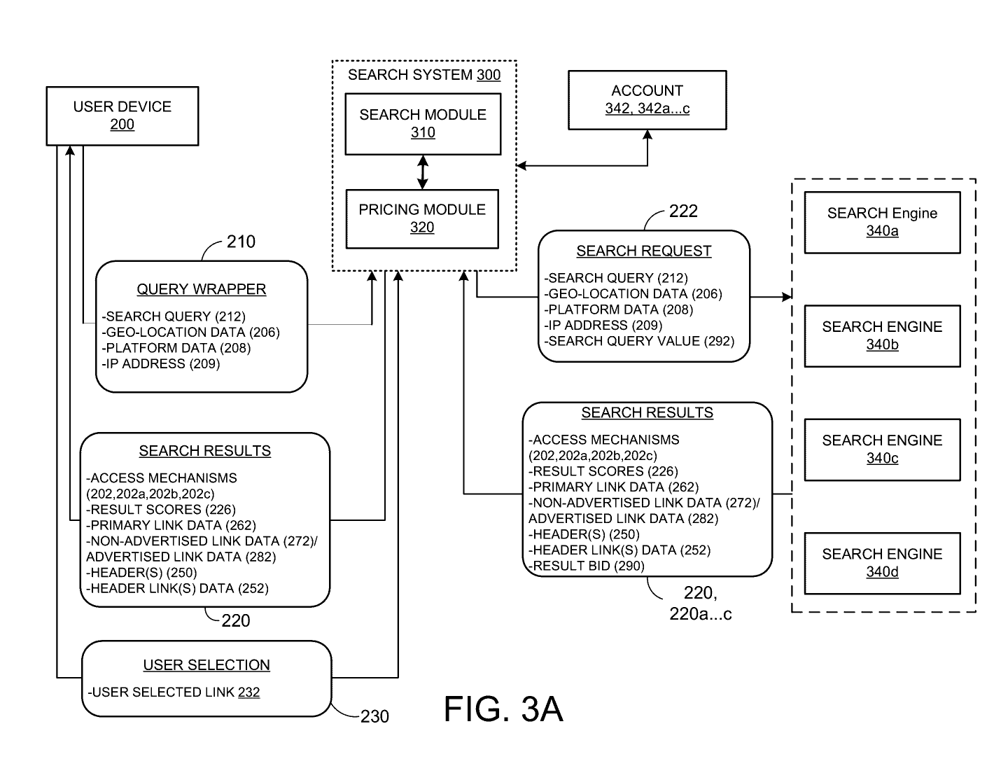

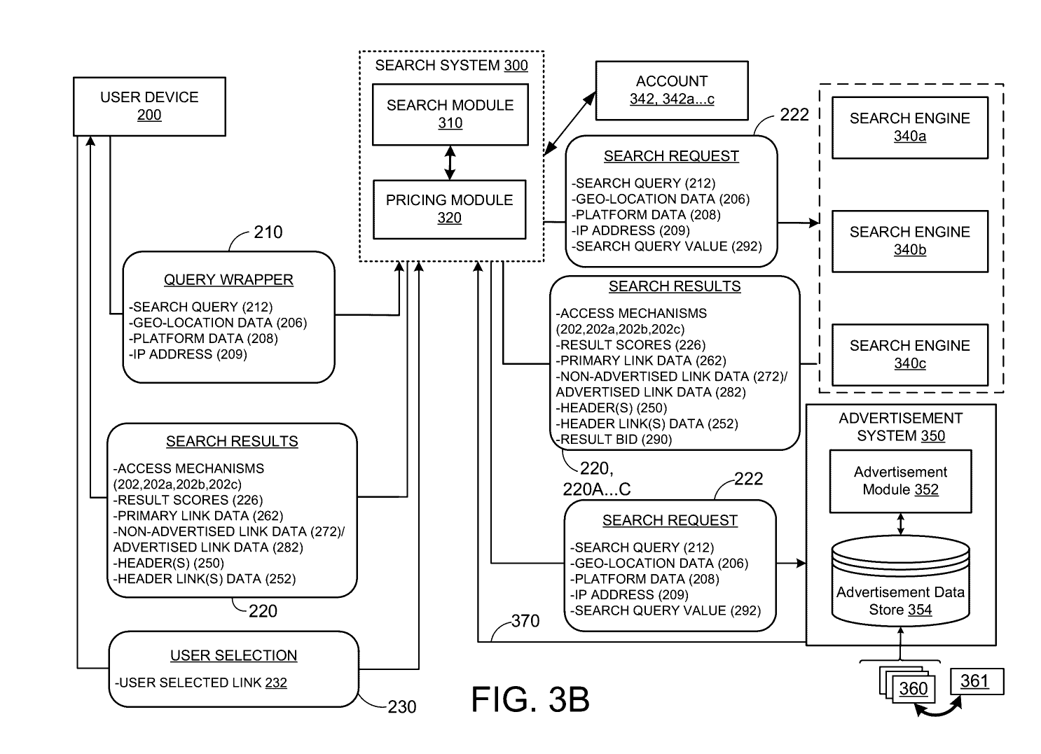

Referring to FIGS. 2A and 3A-3C, the user device 200 may generate user selectable links 250, 260, 270, 280 based on the received search results 220. Each user selectable link 250, 260, 270, 280 displayed to the user 10 may include an access mechanism 202. The user 10 may select a user selectable link 250, 260, 270, 280 on the user device 200 by interacting with the link 250, 260, 270, 280 (e.g., touching or clicking the link 250, 260, 270, 280). In response to selection of a link 260, 270, 280, the user device 200 may launch a corresponding software application 204 (e.g., a native application 204a or a web-browser application 204b) referenced by the access mechanism 202 and perform one or more operations indicated in the access mechanism 202. In some implementations, the links 250, 260, 270, 280 include a header 250 associated with an application, a primary link 260 associated with the application, and secondary links 271 that include non-advertised links 270 and advertised links 280 associated with the primary link 260. In some examples, the secondary links 271 are standardized links. For example, a secondary link 271 may be a navigation link that the user 10 may select to be navigated to an entity 431 associated with the primary link 260 (e.g., of an entity is ‘Diner 1’). Thus, a secondary link 271 that may be standardized is a navigation link 271 (e.g., which may be a non-advertised link 270 or an advertised link 280).

Access mechanisms 202 may include at least one of a native application access mechanism 202a (hereinafter “application access mechanism”), a web access mechanism 202b, and an application download mechanism 202c. The user device 200 may use the access mechanisms 202 to access functionality of applications 204. For example, the user 10 may select a user selectable link 250, 260, 270, 280 including an access mechanism 202 in order to access functionality of an application 204 indicated in the user selectable link 250, 260, 270, 280. The search module 310 may transmit one or more application access mechanisms 202a, one or more web access mechanisms 202b, and one or more application download mechanisms 202c to the user device 200 in the search results 220.

An application access mechanism 202a may be a string that includes a reference to a native application 204a and indicates one or more operations for the user device 200 to perform. If a user 10 selects a user selectable link 250, 260, 270, 280 including an application access mechanism 202a, the user device 200 may launch the native application 204a referenced in the application access mechanism 202a and perform the one or more operations indicated in the application access mechanism 202a.

An application access mechanism 202a includes data that the user device 200 can use to access functionality provided by a native application 204a. For example, an application access mechanism 202a can include data that causes the user device 200 to launch a native application 204a and perform a function associated with the native application 204a. Performance of a function according to the access mechanism 202 may set the native application 204a into a specified state. Accordingly, the process of launching a native application 204a and performing a function according to an application access mechanism 202a may be referred to herein as launching the native application 204a and setting the native application 204a into a state that is specified by the application access mechanism 202a. In some examples, an application access mechanism 202a for a restaurant reservation application can include data that causes the user device 200 to launch the restaurant reservation application and assist in making a reservation at a restaurant. In such examples, the restaurant reservation application may be set in a state that displays reservation information to the user 10, such as a reservation time, a description of the restaurant, and user reviews. In additional examples, an application access mechanism 202a for an internet media player application can include data that causes the user device 200 to launch the internet media player application and stream media from the Internet. In such examples, the internet media player application may be set in a state that displays information regarding the media (e.g., music) being streamed, such as a song name, an artist, or an album name.

Application access mechanisms 202a may have various different formats and content. The format and content of an application access mechanism 202a may depend on the native application 204a with which the application access mechanism 202 is associated and the operations that are to be performed by the native application 204a in response to selection of the application access mechanism 202a. For example, an application access mechanism 202a for an internet music player application may differ from an application access mechanism 202a for a shopping application. An application access mechanism 202a for an internet music player application may include references to musical artists, songs, and albums, for example. The application access mechanism 202a for an internet music player application may also reference operations, such as randomizing a list of songs and playing a song or album. An application access mechanism 202a for a shopping application may include references to different products that are for sale. The application access mechanism 202a for the shopping application may also include references to one or more operations, such as adding products to a shopping cart and proceeding to a checkout.

The search system 300 may include additional data received from the search engines 340a . . . d in the search results 220 along with the application access mechanisms 202a. For example, the search system 300 may transmit data (e.g., link data 252, 262, 272, 282, such as text and/or images), which may be used by the user device 200 to generate user selectable links 250, 260, 270, 280 in the search results 220. A link 250, 260, 270, 280 may include text and/or images that the user 10 may select (e.g., touch) via a user interface 240 displayed on a screen 201 (e.g., a display or touch screen) of the user device 200. Each user selectable link 250, 260, 270, 280 may be associated with an application access mechanism 202a such that when the user 10 selects a link 250, 260, 270, 280, the user device 200 launches the native application 204a referenced in the application access mechanism 202a and performs the one or more operations indicated in the application access mechanism 202a. The text and/or images of a link 250, 260, 270, 280 displayed to the user 10 may indicate the operations that may be performed in response to selection of the link 250, 260, 270, 280. For example, if the link 250, 260, 270, 280 is to a song in a music playing application, the text and/or images may identify the music application that may be launched by the user device 200 and the song that may be played by the music playing application when the user 10 selects the link 250, 260, 270, 280.

The user 10 may select a link 250, 260, 270, 280 to cause the user device 200 to launch the native application 204a identified in the link 250, 260, 270, 280 and perform one or more operations according to the application access mechanism 202a associated with the link 250, 260, 270, 280 and send the user selection 230 to the search system 300. Put another way, when the user 10 selects a link 250, 260, 270, 280, the user device 200 launches a native application 204a and sets the native application 204a into a state defined by the application access mechanism 202a associated with the link 250, 260, 270, 280, and returns the user selected link 250, 260, 270, 280 in the user selection 230 as the user selected link 232. In general, a state of a native application 204a may refer to the operations and/or the resulting outcome of the native application 204a in response to selection of a link 250, 260, 270, 280. A state of a native application 204a may also be referred to herein as an “application state.”

An application state specified by an application access mechanism 202a may depend on the functionality provided by the native application 204a. For example, if a native application 204a is configured to retrieve and display information from the Internet, the native application 204a can be set into a state in which the native application 204a retrieves information from the Internet and displays information to the user 10. In another example, if a native application 204a is configured to play media (e.g., music and/or video) from the Internet, the native application 204a can be set into a state in which the native application 204a is playing a song or a movie from the Internet. In another example, if a native application 204a is configured to make restaurant reservations, the native application 204a can be set into a state in which the native application 204a displays available restaurant reservations to the user 10.

A web access mechanism 202b may include a resource identifier that includes a reference to a web resource (e.g., a page of a web application/website). For example, a web access mechanism 202b may include a uniform resource locator (URL) (i.e., a web address) used with hypertext transfer protocol (HTTP). If a user 10 selects a user selectable link 250, 260, 270, 280 including a web access mechanism 202b. the user device 200 may launch the web browser application 204b and retrieve the web resource indicated in the resource identifier. Put another way, if a user 10 selects a user selectable link 250, 260, 270, 280 including a web access mechanism 202b, the user device 200 may launch a corresponding web-browser application 204b and access a state (e.g., a page) of a web application/website. In some examples, web access mechanisms 202b include URLs for mobile-optimized sites and/or full sites.

The web access mechanism 202b may be used by a web browser to access a web resource that includes similar information and/or performs similar functions as would be performed by a native application 204a that receives an application access mechanism 202a. For example, the web access mechanism 202b may direct the web-browser application 204b of the user device 200 to a web version of the native application 204a referenced in the application access mechanisms 202a. Moreover, if the application access mechanisms 202 for a specific Mexican restaurant cause each application edition to retrieve information for the specific Mexican restaurant, the web access mechanism 202b may direct the web-browser application 204b of the user device 200 to a web page entry for the specific Mexican restaurant.

An application download mechanism 202c may indicate a location (e.g., a digital distribution platform) where a native application 204a can be downloaded in the scenario where the native application 204a is not installed on the user device 200. If a user 10 selects a user selectable link 250, 260, 270, 280 including an application download mechanism 202a, the user device 200 may access a digital distribution platform from which the referenced native application 204a may be downloaded. The user device 200 may access a digital distribution platform using at least one of the web-browser application 204b and one of the native applications 204a.

An application access mechanism 202a may be an application resource identifier or a string that includes a reference to a native application 204a and/or indicates one or more operations for execution by the native application 204a on the user device 200. An application resource identifier is a string having an application specific scheme in some examples. For example, the application resource identifier may include a reference to a native application 204a, a domain name, and a path to be used by the native application 204a to retrieve and display information to the user 10. In some examples, an application resource identifier is an application specific resource identifier that is defined by the developer of the application 204. In this example, the search application 216 receives the application resource identifier and the operating system 228 may send the application resource identifier to the native application 204a referenced in the application resource identifier. The native application 204a referenced in the application resource identifier launches and is set into the state specified by the application resource identifier.

In some examples, the application access mechanism 202a includes operations for the user device 200 to perform in addition to the operation(s) indicated in the application resource identifier. For example, the search application 216, the operating system 228, and/or a native application 204a on the user device 200 may perform the operations included in the application access mechanism 202a. In some examples, a script includes the operations. Examples of operations may include, but are not limited to, launching a native application 204a, creating and sending a search query 212 or search request (via a query wrapper 210) to an application server 112, setting a current geographic location in a native application 204a, making a restaurant reservation, sending a text message, and adding an appointment to a calendar.

In some examples, an application access mechanism 202a does not include an application resource identifier. Instead, the application access mechanism 202a includes one or more operations that reference a native application 204a and indicate one or more operations for execution by the user device 200. The one or more operations may include instructions for at least one of the search application 216, the operating system 228, and/or a native application 204a on the user device 200. In response to selection of the application access mechanism 202a, the user device 200 may perform the operations included in the application access mechanism 202a. In some examples, the operations are included in a script.

In some examples, an application function is not be accessible using an application resource identifier. For example, a function of the application may not include a corresponding application resource identifier that the application 204 may use to perform the function. As another example, some applications 204 may not be configured to receive application resource identifiers. In these examples, an application access mechanism 202 for the native application 204a can include one or more operations that cause the native application to perform the function that may not otherwise be accessible using an application resource identifier. For example, the search application 216 may receive the one or more operations and execute the one or more operations to set the native application 204a into the desired application state. In some examples, the one or more operations include launching the native application 204a along with additional operations for the native application 204a to perform. For example, the search application 216 may initially trigger the native application 204a to start and then wait for a period of time for the native application 204a to start. Then the search application 216 may perform additional operations included in the received application access mechanism 202, such as issuing a search instruction to the native application 204a.

In still other examples, a native application 204a may be configured to directly receive the operations transmitted by the search system 300. In these examples, the native application 204a may be launched according to the application access mechanism 202 and then the launched native application 204a may directly perform the operations received from the search system 100.

A single native application 204a can provide a variety of different functionalities. For example, a restaurant reservation application can access reviews for a variety of different restaurants and set up reservations at a variety of different restaurants. Similarly, a travel application can book hotels, book flights, and provide reviews for different travel destinations. The different functionalities associated with a single native application 204a may be accessed using a plurality of different application access mechanisms 202.

The application access mechanisms 202 for a single native application 204a may vary in complexity. In some examples, the application access mechanisms 202 cause a native application 204a to launch (e.g., the operating system 228 may be instructed to launch the application 204) and then perform additional operations after launching, as described above. In other examples, application access mechanisms 202 may cause an application 204 to launch into a default state (e.g., a default homepage) without performing any additional operations. An application access mechanism 202 that causes an application 204 to launch into a default state may be thought of as an access mechanism 202 that is related to the native application 204a, but not any particular state, which may be accessed by the application 204.

In some examples, the search application 216 is a native application 204a installed on the user device 200. For example, the search application 216 may receive search queries 212. generate the query wrapper 210, display received data that is included in the search results 220, and return the user selection 230. In additional examples, the user device 200 may execute a web-browser application 204b that accesses a web-based search application. In this example, the user 10 may interact with the web-based search application via a web-browser application 204b installed on the user device 200. In still more examples, the functionality attributed to the search application 216 may be included as a searching component of a larger application 204 that has additional functionality. For example, the functionality attributed to the search application 216 may be included as part of a native/web-browser application 204a, 204b as a feature that provides search for the native/web-browser application 204a, 204b.

The user device 200 may receive a set of search results 220 from the search module 310 in response to transmission of the query wrapper 210 to the search system 300. The GUI 240 of the search application 216 displays (e.g., renders) the search results 220 received from the search module 310. The search application 216 may display the search results 220 to the user 10 in a variety of different ways, depending on what information is transmitted to the user device 200. In examples where the search results 220 include a list of access mechanisms 202 and link data, the search application 216 may display the search results 220 to the user 10 as a list 251 of user selectable links 260, 270 including text and images. The user selectable links 260, 271 may include primary user-selectable links 260 associated with the primary search results 220, and secondary user-selectable links 271. The text and images in the links 260, 271 may include application names associated with the access mechanisms 202, text describing the access mechanisms 202, images associated with the application 204 referenced by the access mechanisms 202 (e.g., application icons), and images associated with the application state (e.g., application screen images) defined by the access mechanisms 202. One or more secondary user-selectable link(s) 271 can be associated with a primary user-selectable link 260.

In some implementations, the search application 216 displays the search results 220 as a list of primary links 260 arranged under the search field 214 in which the user 10 entered the search query 212, and each primary link 260 may include one or more secondary links 271 associated with the primary link 260. Moreover, the search application 216 may arrange the primary links 260 in order based on result bids 290 associated with the search results 220 received by the search engines 340a . . . d including access mechanisms 202 included in the primary links 260. In addition, the search application 216 may arrange the secondary links 271 in order based on the result bid 290, result scores 226 or functionality. In some examples, the search application 216 groups the primary links 260 together if the primary links 260 are related to the same application 204 displayed in the header 250.

Each of the primary links 260 includes link data 262, and each of the secondary links 270 optionally includes link data 272. For example, each of the primary or secondary links 260, 271 includes link data 262, 272, 282, such as an image (e.g., an icon) and text (e.g., an application or business name) that may describe an application displayed in the header 250 and a state of an application. Each of the links 260, 270 may include an access mechanism 202 so that if a user 10 selects one of the links 260, 270, the user device 200 launches the application 204 and sets the application 204 into a state that is specified by the access mechanism 202 associated with the selected link 260, 270. In some implementations, the user device 200 arranges the primary links 260 based on result scores associated with the access mechanisms 202 included in the primary links 260. In some implementations, as illustrated in FIG. 2A, primary links 260 for the same application 204 are combined together in the search results 220 displayed to the user 10, and secondary links 271 for the same primary link 260 are combined together in the search results 220 displayed to the user 10.

Referring to FIG. 3A, the user device 200 requests a search by creating a query wrapper 210 including a search query 212 and sending the query wrapper 210 to the search system 300. The search system 300 includes the search module 310 and pricing module 320 in communication with each other. The pricing module 320 examines the query wrapper 210 to determine a search query value 292. The pricing module 320 can use various pieces of data to determine the search query value 292. For example, the pricing module 320 might examine the previous search query values 292 of similar search queries 212 that occurred before, the geo-location data 206, the platform data 208, IP address 209, the expected total results bid 290 from similar search queries 212, the expected profit from the search query 212, the expected user value from the search query 212, and/or a combination of this information. Once the pricing module 320 has determined the search query value 292, the pricing module 320 passes this information back to the search module 310. The search module 310 adds the search query value 292 to the information contained in the query wrapper 210 and creates the search request 222 containing the at minimum the search query 212 and search query value 292. In some examples, the search request includes the search query 212, the geo-location data 206, the platform data 208, the IP address 209 and the search query value 292.

The search system 300 broadcasts the search request 222 to a plurality of search engines 340a . . . d. There is no limit to the number of search engines 340 that the search request can be broadcast to. Each search engine 340 may examine the search request 222 and make its own determination as to the value the search engine 340 can provide. If the search engine 340 determines that the value it can provide is sufficient to justify the expense of the result bid 290 in relation to the search query value 292, the search engine 340 may choose to provide search results 220 to the search system 300. The result bid 290 is the cost of the search engine 340 to be included in the search results 220 sent to the user 10 to be displayed in the list 251.

Once the search system 300 has received enough search results 220 from the search engine 340 or sufficient time has passed, the search module 310 compiles the search results 220 into a single search result 220 to be sent to the user 10 as a list 251. The pricing module 320 takes the value of the result bid 290 in each of the search results 220 provided by the search engine 340. The pricing module 320 deducts the value corresponding to the result bid 290 from the account 342 associated with the search engine 340 that provided those search results 220. In some examples, result bids 290 may relate to a search position and may be excluded if the search results 220 are not the highest bid for the given search position. Result bids 290 may also be reduced if the search result 220 is not in the desired search position based on a new position.

The search system 300 provides the search results 220 to the user 10 (directly or indirectly through an intermediary system) in any acceptable format. The search results 220 may include user selectable links 260, 271, or application access mechanisms 202 and presented to the user 10 in various forms as discussed above. The user 10 makes a selection appropriate to what they are looking for based on the search query 212. Upon the selection by the user 10, the user device 200 returns a user selection 230 including a 5 user selected link 232 to the search system 300. The pricing module 320 determines which search engine 340 provided the search result 220 and credits the account 342 associated with the search engine 340 the amount associated with the search query value 292.

In one example, a search query 212 for late night food is requested by the user 10. The search query 212 for late night food is placed in a query wrapper 210 including the geo-location data 206, the platform data 208, and the IP address 209. The user device 200 sends the query wrapper 210 to the search system 300. The pricing module 320 examines the query wrapper 210 and determines that a search query 212 of late night food from the associated geo-location data 206, platform data 208, and IP address 209 has a search query value 292 of $5.00. The search module 310 takes the search query value 292 and adds it to the existing query wrapper 210 creating the search request 222. The search system 300 then broadcasts the search request 222 for any search engine 340 to respond. A first search engine 340a determines that it will provide a search result 220 of Diner 1 260aa, and be willing to pay $3.00 to provide that search result 220. The first search engine 340a returns a first search result 220a of Diner 1 260aa, and places a value of $3.00 in the result bid 290 sent with the first search result 220a. A second search engine 340b determines that it will provide a search result 220 of Diner 2 260ab, and be willing to pay $2.00 to provide that search result 220. The second search engine 340b returns a second search result 220b of Diner 2 260ab, and places a value of $2.00 in the result bid 290 sent with the second search result 220b. A third search engine 340c, determines that it will provide a search result 220 of Diner 3 260ac, and be willing to pay $1.10 to provide that search result 220. The third search engine 340c returns a third search result 220c of Diner 3 260ac, and places a value of $1.10 in the result bid 290 sent with the third search result 220c. A fourth search engine 340d, determines that it will not provide a search result 220, because it does not have a relevant search result 220 or it feels its search result 220 would not be competitive.

The search system 300 receives the first search result 220a, second search result 220b, and third search result 220c. The search module 310 orders the search results 220a . . . c based on the corresponding result bids 290 contained within or associated with each search result 220a . . . c. The pricing module 320 charges a first account 342a associated with the first search engine 340a the result bid 290 of $3.00. The pricing module 320 charges a second account 342b associated with the second search engine 340b the result bid 290 of $2.00. The pricing module 320 charges a third account 342c associated with the third search engine 340c the result bid 290 of $1.10. The search module 310 sends the combined search results 220 including the first search result 220a, second search result 220b, and third search result 220c to the user device 200. The search results 220 are displayed to the user 10. Upon the user 10 selecting a search result 220 displayed as a user selectable link 250, 260, 270, the user device 200 sends the user selection 230 to the search system 300. In this example, the user 10 selected Diner 2 260ab from the second search results 220b provided by the second search engine 340b. The pricing module 320 determines that the user 10 selected link 260ab was from the second search results 220b and provided by the second search engine 220b. The pricing module 320 credits the second account 342b associated with the second search engine 340b, the search query value 292 of $5.00. As a result, the search system 300 earned $1.10 and the second search engine 340b earned $3.00 for providing the most relevant search result 220.

In some examples, the search query value 292 does not have to be a value but instead can be a percentage. A percentage search query value 292 could indicate the percentage of the total money collected that would be returned to the search engine 340 the user 10 selects. The result bid 290 could also be a percentage, representative of the percentage of the search query value 292 that it would be willing to pay for a search result 220 to be displayed. In some examples, external advertisers could disrupt the system by providing search results 220 that are not relevant to the search query 212. One approach to discourage this behavior is to charge more for non-search engine providers to submit a search result 220, such as providing half of the amount of money entered into the account 340 as an advertiser tax. In some implementations, the money added to the account 342 could convert to a search credit at a lower value. This would allow search engines 340 who provide successful search results 220 and are net positive to not have to pay a fee to continue to operate. By contrast, search engines 340 who are net negative in expenses would have to continue to pay the fee of converting money to search credit in order to operate.

FIG. 3B shows the search system 300 including a connection to an advertisement system 350. The advertisement system 350 receives a search request 222 from search system 300 and the advertisement system 350 performs a search and/or analysis within each of its respective databases (i.e., advertising data store 354) to identify one or more advertisements 360 for sending corresponding advertisement results 370 to the search system 300 to be included in the search results 220. In some examples, it is desirable to include personalized or targeted advertisement 361 (i.e., advertisement results 370) based on an advertisement request or the search request 222 and a user profile record associated with a user 10. There are numerous ways to determine the appropriate and correct advertising. Any of the traditional methods may be suitable.

In some examples, the advertisement system 350 communicates with the pricing module 320 in order for the pricing module 320 to determine the correct search query value 292. The advertisement system 350 can also provide an advertisement score related to an index score, price per action value, and probability of action. The advertisement score may also be used to determine the search query value 292. The advertisement system 350 may also select advertisements 360 based on triggering data, and or an inverted index that indexes the advertisements based on triggering data.

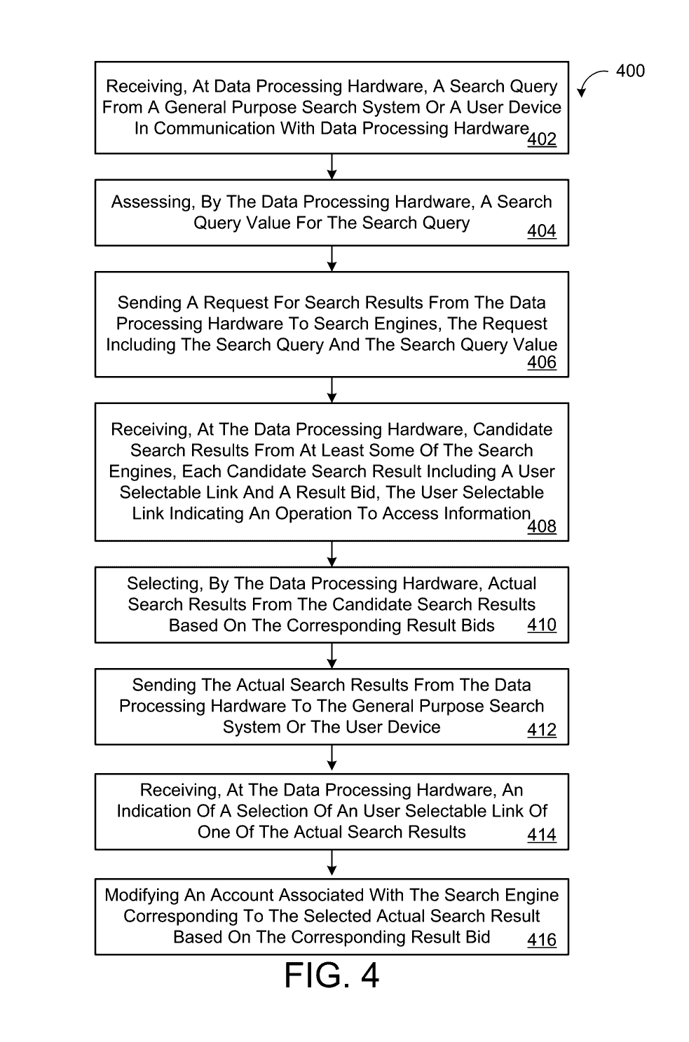

FIG. 4 shows a method 400 for operating a search system 300. At block 402, the method 400 includes receiving, at data processing hardware 500, a search query 212 from a general purpose search system or a user device 200 in communication with the data processing hardware 500. The user device 200 may communicate the search query 212 alone or as part of a query wrapper 210 including additional information. At block 404, the method 400 includes assessing, by the data processing hardware 500, a search query value 292 for the search query 212. The search system 300 and/or pricing module 320 generates a search query value 292 related to the value of the search query 212 received. At block 406. the method 400 includes sending a request for search results or a search request 222 from the data processing hardware 500 to search engines 340, the request includes the search query 212 and the search query value 292. The search system 300 includes the search module 310 and pricing module 320 and broadcasts a search request 222 including the search query 212 and search query value 292. At block 408, the method 400 includes receiving, at the data processing hardware 500, candidate search results 220 from at least some of the search engines 340, each candidate search result 220 comprising a user selectable link 260 and a result bid 290, the user selectable link 260 indicating an operation to access information. The various search engines 340a . . . d may choose to participate in the search for a cost. The result bid 290 determines if the search result 220 may be displayed by the user device 200. At block 410, the method 400 includes selecting, by the data processing hardware 500, actual search results 220 from the candidate search results 220 based on the corresponding result bids 290. The search system 300 orders the search results 220 based on the value of the result bid 290. At block 412, the method 400 includes sending the actual search results 220 from the data processing hardware to the general purpose search system or the user device 200. After the search results 220 have been ordered into a list 251 based on the result bids 290, the list 251 and search results 220 are sent to the user device 200. At block 414, the method 400 includes receiving, at the data processing device hardware 500, an indication of a selection 230 of a user selectable link 260 of one of the actual search results 220. Once the user 10 takes an action selecting a user selected link 232 and/or application link, the user device 200 sends the user selection 230 to the search system 300. The user selected link 232 is included in the user selection 230 and indicates which search result 220 the user 10 selected. At block 416, the method 400 includes modifying an account 342 associated with the search engine 340 corresponding to the selected actual search result 220 or user selection 230. The pricing module 320 may send the search query value 292 to the account 342 associated with the search engine 340 that provided the search result 220 the user 10 selected.

In some implementations, the method 400 includes sending at least one advertisement 361 with the actual search results 220 from the data processing hardware 500 to the general purpose search system or the user device 200. The method 400 may also include selecting the at least one advertisement 361 from a collection of advertisements 360 based on the search query 212. The method 400 may include selecting the at least one advertisement 361 from the collection of advertisements 360 based on a price-per-action value and a probability of action of each advertisement 361. The action or user 10 may include a user selection 230 of the advertisement 361.

In some examples, the search query value 292 is based on a probability of a user selection 230 of the at least one advertisement 361 for the search query 212. At least one advertisement 361 may include advertisement data and an advertisement access mechanism 202 having a reference to a corresponding application 216 installed on the user device 200. The advertisement access mechanism 202 may indicate a performable operation for the corresponding application 216 relating to the advertisement 361. The user selectable link 260 may include an application access mechanism 202 associated with an application 216 executable on the user device 200. The access mechanism 202 may indicate a performable operation for the corresponding application 216. Each candidate search result 220 may include at least one of an image or text. At least one candidate search result 220 may include an advertisement 360.

In some implementations, the method 400 includes receiving, at the data processing hardware 500, the candidate search results 220 for a threshold period of time. After the threshold period of time, the method 400 may include ceasing receipt of the candidate search results 220 and selecting, by the data processing hardware 500, actual search results 220 from the candidate search results 220 received during the threshold period of time. The method 400 may also include ordering, by the data processing hardware 500, the actual search results 220 based on the corresponding result bids 290. Modifying the account 342 associated with the search engine 340 corresponding to the selected actual search result 220 may include crediting the account 342 with a payout value based on the result bid 290 or search query value 292 corresponding to selected actual search results 220. Modifying the account 342 associated with the search engine 340 corresponding to the selected actual search result 220 may further include crediting the account 342 with a payout value based on the result bid 290 corresponding to selected actual search results 220. The result bid 290 may be limited to less than the search query value 292.

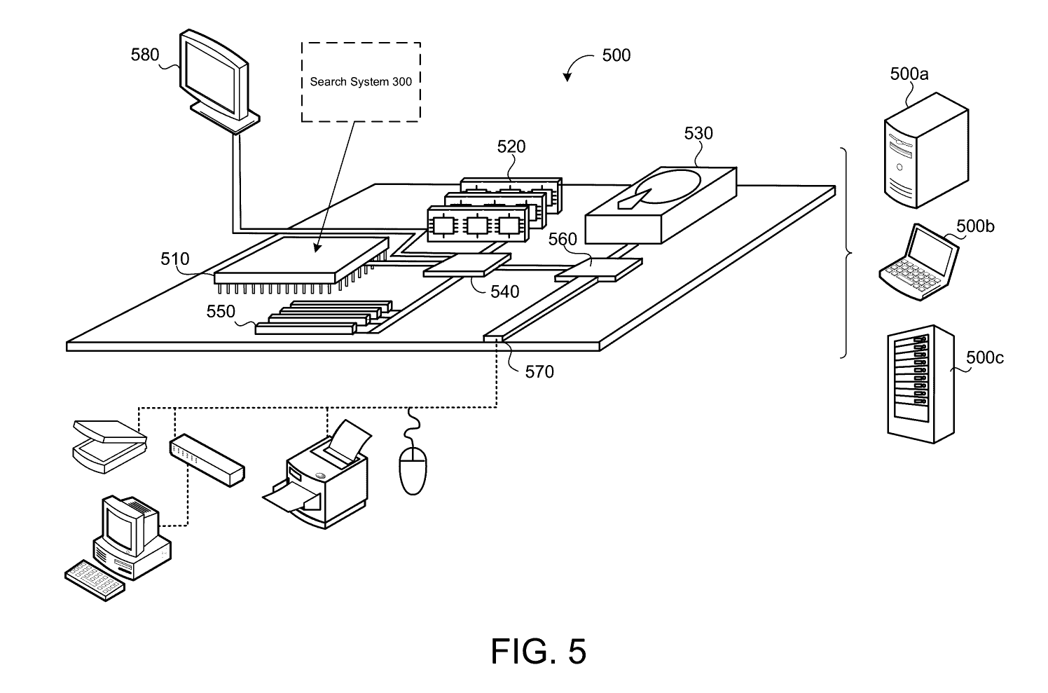

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to low speed bus 570 and storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and low-speed expansion port 570. The low-speed expansion port 570, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at data processing hardware, a search query from a general purpose search system or a user device in communication with the data processing hardware;
assessing, by the data processing hardware, a search query value for the search query;
sending a request for search results from the data processing hardware to search engines, the request including the search query and the search query value;
receiving, at the data processing hardware, candidate search results from at least some of the search engines, each candidate search result comprising a user selectable link and a result bid, the user selectable link indicating an operation to access information;
selecting, by the data processing hardware, actual search results from the candidate search results based on the corresponding result bids;
sending the actual search results from the data processing hardware to the general purpose search system or the user device;
receiving, at the data processing hardware, an indication of a selection of a user selectable link of one of the actual search results; and
modifying an account associated with the search engine corresponding to the selected actual search result.

2. The method of claim 1, further comprising sending at least one advertisement with the actual search results from the data processing hardware to the general purpose search system or the user device.

3. The method of claim 2, further comprising selecting the at least one advertisement from a collection of advertisements based on the search query.

4. The method of claim 3, further comprising selecting the at least one advertisement from the collection of advertisements based on a price-per-action value and a probability of action of each advertisement, the action comprising a user selection of the advertisement.

5. The method of claim 3, wherein the search query value is based on a probability of a user selection of the at least one advertisement for the search query.

6. The method of claim 2, wherein the at least one advertisement comprises advertisement data and an advertisement access mechanism having a reference to a corresponding application installed on the user device, the advertisement access mechanism indicating a performable operation for the corresponding application relating to the advertisement.

7. The method of claim 1, wherein the user selectable link comprises an application access mechanism associated with an application executable on the user device, the access mechanism indicating a performable operation for the corresponding application.

8. The method of claim 1, wherein each candidate search result further comprises at least one of an image or text.

9. The method of claim 1, wherein at least one candidate search result comprises an advertisement.

10. The method of claim 1, further comprising:
receiving, at the data processing hardware, the candidate search results for a threshold period of time;
after the threshold period of time, ceasing receipt of the candidate search results; and
selecting, by the data processing hardware, actual search results from the candidate search results received during the threshold period of time.

11. The method of claim 1, further comprising ordering, by the data processing hardware, the actual search results based on the corresponding result bids.

12. The method of claim 1, wherein modifying the account associated with the search engine corresponding to the selected actual search result comprises crediting the account with a payout value based on a difference between the search query value and the result bid corresponding to selected actual search result.

13. The method of claim 1, wherein modifying the account associated with the search engine corresponding to the selected actual search result comprises crediting the account with a payout value based on the search query value corresponding to selected actual search result.

14. The method of claim 1, wherein the result bid is limited to be less than the search query value.

15. A system comprising:
data processing hardware; and
memory hardware in communication with the data processing hardware, the memory hardware storing instructions that when executed on the data processing hardware cause the data processing hardware to perform operations comprising:
receiving a search query from a general purpose search system or a user device in communication with the data processing hardware;
assessing a search query value for the search query;
sending a request for search results to search engines, the request including the search query and the search query value;
receiving candidate search results from at least some of the search engines, each candidate search result comprising a user selectable link and a result bid, the user selectable link indicating an operation to access information;
selecting actual search results from the candidate search results based on the corresponding result bids;
sending the actual search results to the general purpose search system or the user device;
receiving an indication of a selection of a user selectable link of one of the actual search results; and
modifying an account associated with the search engine corresponding to the selected actual search result.

16. The system of claim 15, wherein the operations further comprise sending at least one advertisement with the actual search results from the data processing hardware to the general purpose search system or the user device.

17. The system of claim 16, wherein the operations further comprise selecting the at least one advertisement from a collection of advertisements based on the search query.

18. The system of claim 17, wherein the operations further comprise selecting the at least one advertisement from the collection of advertisements based on a price-per-action value and a probability of action of each advertisement, the action comprising a user selection of the advertisement.

19. The system of claim 17, wherein the search query value is based on a probability of a user selection of the at least one advertisement for the search query.

20. The system of claim 16, wherein the at least one advertisement comprises advertisement data and an advertisement access mechanism having a reference to a corresponding application installed on the user device, the advertisement access mechanism indicating a performable operation for the corresponding application relating to the advertisement.

21. The system of claim 15, wherein the user selectable link comprises an application access mechanism associated with an application executable on the user device, the access mechanism indicating a performable operation for the corresponding application.

22. The system of claim 15, wherein each candidate search result further comprises at least one of an image or text.

23. The system of claim 15, wherein at least one candidate search result comprises an advertisement.

24. The system of claim 15, wherein the operations further comprise:
receiving the candidate search results for a threshold period of time;
after the threshold period of time, ceasing receipt of the candidate search results; and
selecting actual search results from the candidate search results received during the threshold period of time.

25. The system of claim 15, wherein the operations further comprise ordering the actual search results based on the corresponding result bids.

26. The system of claim 15, wherein modifying the account associated with the search engine corresponding to the selected actual search result comprises crediting the account with a payout value based on a difference between the search query value and the result bid corresponding to selected actual search result.

27. The system of claim 15, wherein modifying the account associated with the search engine corresponding to the selected actual search result comprises crediting the account with a payout value based on the search query value corresponding to selected actual search result.

28. The system of claim 15, wherein the result bid is limited to be less than the search query value.
